(19) United States
(12) Patent Application Publication
(10) Pub. No.: US 2024/0105963 A1
(43) Pub. Date: Mar. 28, 2024

(54) METHOD FOR MANUFACTURING GAS DIFFUSION LAYER FOR FUEL CELL AND GAS DIFFUSION LAYER MANUFACTURED THEREBY

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Seung Tak Noh, Yongin-si (KR); Ji Han Lee, Seongnam-si (KR); In Seok Lee, Yongin-si (KR); Jae Man Park, Yongin-si (KR); Won Jong Choi, Incheon (KR); Choong Hee Kim, Incheon (KR); Seong Hwang Kim, Seoul (KR); Jong Hoon Lee, Incheon (KR); Soo Jin Park, Seoul (KR); Seul Yi Lee, Incheon (KR)

(21) Appl. No.: 18/117,568

(22) Filed: Mar. 6, 2023

(30) Foreign Application Priority Data
Sep. 22, 2022 (KR) 10-2022-0120050

(51) Int. Cl. H01M 4/88; H01M 4/90; H01M 8/1004

(52) U.S. Cl. CPC H01M 4/8807; H01M 4/8846; H01M 4/8882; H01M 4/9083; H01M 8/1004

(57) ABSTRACT

A method for manufacturing a gas diffusion layer for a fuel cell wherein carbon nanotubes are impregnated into Korean paper, thereby enhancing electroconductivity, and a gas diffusion layer manufactured thereby. The method for manufacturing a gas diffusion layer for a fuel cell which is to manufacture a gas diffusion layer as a constituent member of a unit cell in a fuel cell, includes a support preparation step of preparing a support with Korean paper; a dispersion preparation step of dispersing a carbon substance in a solvent to form a dispersion, a coating step of coating the support with the dispersion, and a thermal treatment step of thermally treating the dispersion-coated support to fix the carbon substance to the support.

### CROSS REFERENCE TO RELATED APPLICATIONS

This application is based on and claims priority under 35 U.S.C. § 119 to Korean Patent Application No. 10-2022-0120050, filed on Sep. 22, 2022, in the Korean Intellectual Property Office, the disclosure of which is herein incorporated by reference in its entirety.

### BACKGROUND

### 1. Field

The present disclosure relates to a method for manufacturing a gas diffusion layer for a fuel cell and a gas diffusion layer manufactured thereby and, more specifically, to a method for manufacturing a gas diffusion layer for fuel cells, wherein carbon nanotubes are impregnated into Korean paper, thereby enhancing electroconductivity, and a gas diffusion layer manufactured thereby.

### 2. Description of the Prior Art

A fuel cell is a kind of generator that electrochemically reacts chemical energy of fuel in a stack to convert the chemical energy into electric energy. The fuel cell may be used to supply not only driving power for industry, home and vehicles but also power for handheld electronic devices, such as portable devices. Recently, the use field of the fuel cell is being gradually expanded as a clean energy source with high efficiency.

FIG. 1 is a view showing a unit cell in a general fuel cell.

As shown in FIG. 1, a unit cell in a general fuel cell includes a membrane-electrode assembly 10 (MEA) located at the innermost site thereof. The MEA is composed of a polymer electrolyte membrane 11 capable of moving hydrogen cations (protons) and catalytic layers, that is, anode 12 and cathode 13 coated respectively on opposite surfaces of the electrolyte membrane so as to react hydrogen with oxygen.

In addition, a gas diffusion layer (GDL) 20 is deposited on each of the outer surfaces of the MEA 10, that is, each of the outer surfaces of the anode 12 and the cathode 13, and a separator 30 which has a flow field formed therein to supply the fuel to the outside and discharge the water produced during the reaction is disposed on each of the outer surfaces of the gas diffusion layers 20.

In this regard, the gas diffusion layer 20 should retain excellent electroconductivity because it plays important roles in the polymer electrode membrane fuel cell, such as function of uniformly supplying hydrogen and oxygen into the polymer electrolyte membrane 11 of the MEA 10 and function as an electric conductor to moving the electrons reacted in the catalytic layers 12 and 13 to the separator 30.

Accordingly, carbon fibers, which are thermally treated for carbonization and have excellent electroconductivity and low electric resistance, have recently attracted attention as a substance for the gas diffusion layer.

For instance, the gas diffusion layer 20 is prepared by forming a micro-porous layer (MPL) 22 in a substrate 21 composed of carbon fiber.

The substrate 21 is configured to have a hydrophobic agent, such as polytetrafluoroethylene (PTFE), impregnated into carbon fibers. For example, the carbon fibers may be in the form of carbon fiber cloth, carbon fiber felt, or carbon fiber paper.

The micro-porous layer 22 can be formed by mixing a carbon powder, such as carbon black, acetylene black carbon, black pearls carbon, etc., and a hydrophobic agent, such as polytetrafluoroethylene (PTFE), etc., to prepare a slurry and applying the prepared slurry to one or both surfaces of the substrate 21 according to the purpose.

The preparation of a gas diffusion layer by coating the substrate with the slurry requires uniform dispersion of the slurry across the substrate. However, although the slurry should be uniformly dispersed in an aqueous solution, the dispersion technology is not yet advanced, so the electrical conductivity and electrical resistance of the gas diffusion layer cannot be simultaneously satisfied.

Furthermore, after application of a slurry of a carbon powder and PTFE binder mixture to the substrate, a process of sintering the substrate and the slurry at an ultra-high temperature of about 2200° C. is indispensable for the formation of the micro-porous layer. Accordingly, there is also a problem in that a facility for performing the ultra-high temperature sintering process is needed to manufacture the gas diffusion layer.

The foregoing is intended merely to aid in the understanding of the background of the present disclosure, but is not to be construed to mean that the present disclosure falls within the purview of the related art that is already known to those skilled in the art.

### SUMMARY

The present disclosure provides a method for manufacturing a gas diffusion layer for a fuel cell and a gas diffusion layer manufactured thereby, wherein the gas diffusion layer having carbon nanotube impregnated into Korean paper (hanji) exhibits improved electroconductivity, compared to conventional gas diffusion layers employing carbon fibers.

The technical subjects pursued in the present disclosure may not be limited to the above mentioned technical subjects, and other technical subjects which are not mentioned may be clearly understood, through the following descriptions, by those skilled in the art to which the present disclosure pertains.

A method for manufacturing a gas diffusion layer for a fuel cell according to an embodiment of the present disclosure, which is to manufacture a gas diffusion layer as a constituent member of a unit cell in a fuel cell, includes a support preparation step of preparing a support with Korean paper, a dispersion preparation step of dispersing a carbon substance in a solvent to form a dispersion, a coating step of coating the support with the dispersion, and a thermal treatment step of thermally treating the dispersion-coated support to fix the carbon substance to the support.

In the support preparation step, the Korean paper has a basis weight of 10 to 200 g/m² and a thickness of 10-200 μm.

In the support preparation step, the Korean paper has a porosity of 50-90%.

In the dispersion preparation step, the carbon substance is a carbon nanotube (CNT) or a mixture of carbon nanotube and reduced graphene oxide (rGO).

The mixture includes carbon nanotube (CNT) and reduced graphene oxide (rGO) at a weight ratio of 1:1-10:1.

In the dispersion preparation step, the dispersion is free of a binder.

In the thermal treatment step, the thermal treatment is carried out at a temperature of 800-900° C.

The method further includes a drying step of drying the dispersion-coated support before the thermal treatment step.

The drying step is carried out by maintaining the dispersion-coated support for 7-9 hours in a natural state to spontaneously dry the support.

A gas diffusion layer for a fuel cell according to an embodiment of the present disclosure is a constituent of a unit cell in a fuel cell and includes a substrate layer in which a carbon substance is fixedly impregnated inside a support formed of Korean paper.

The Korean paper responsible for the substrate layer has a base weight of 10 to 200 g/m² and the substrate layer has a thickness of 10-200 μm.

The substrate layer has a porosity of 50-90%.

The carbon substance includes carbon nanotubes alone or a mixture of carbon nanotubes (CNT) and reduced graphene oxide (rGO).

When the carbon substance includes carbon nanotubes alone, the gas diffusion layer has an electroconductivity of 9.00×10¹ S/cm or higher.

When the carbon substance includes a mixture of carbon nanotubes (CNT) and a reduced graphene oxide (rGO), the gas diffusion layer surface has a water drop contact angle of 117° or greater.

The gas diffusion layer further includes a carbon substance layer formed by fixing a carbon substance onto the surface of the substrate layer.

The carbon material layer has a thickness of 50 μm or less.

According to an embodiment of the present disclosure, Korean paper is used to form a substrate layer as a constituent of a gas diffusion layer and a carbon substance such as carbon nanotube (CNT) is impregnated into the substrate layer, whereby there is an expected effect of enhancing electroconductivity while maintaining high mechanical strength.

With a structurally isotropic fibrous structure and improved porosity, Korean paper allows a carbon substance such as carbon nanotube (CNT) to be impregnated thereinto even in the absence of a binder, thus excluding a separate ultra-high temperature sintering process and imparting excellent electrical properties to the gas diffusion layer that can be maintained thinly.

### BRIEF DESCRIPTION OF THE FIGURES

The above and other aspects, features and advantages of the present disclosure will be more apparent from the following detailed description taken in conjunction with the accompanying drawings, in which:

FIG. 1 is a view showing a unit cell in a general fuel cell;

FIG. 2A is a view of a gas diffusion layer for a fuel cell according to an embodiment of the present disclosure;

FIG. 2B is a view of a gas diffusion layer for a fuel cell according to another embodiment of the present disclosure;

FIG. 3 shows SEM images of Korean paper accounting for the substrate layer in the gas diffusion layer for a fuel cell according to an embodiment of the present disclosure;

FIG. 4 shows SEM images of the gas diffusion layer for a fuel cell according to an embodiment of the present disclosure;

FIG. 5A is a photographic image showing a surface contact angle on a gas diffusion layer for a fuel cell when carbon nanotubes (CNT) are used as the carbon substance according to an embodiment of the present disclosure; and

FIG. 5B is a photographic image showing a surface contact angle on a gas diffusion layer for a fuel cell when a mixture of carbon nanotubes (CNT) and a reduced graphene oxide (rGO) is used as the carbon substance according to an embodiment of the present disclosure.

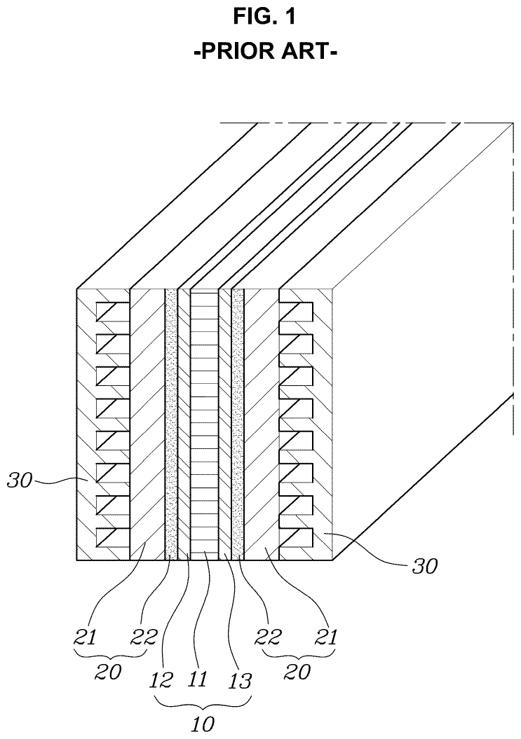

### DETAILED DESCRIPTION

The present disclosure may be variously modified and include various exemplary embodiments in which specific exemplary embodiments will be described in detail hereinbelow. However, it shall be understood that the specific exemplary embodiments are not intended to limit the present disclosure thereto and cover all the modifications, equivalents and substitutions which belong to the idea and technical scope of the present disclosure.

Hereinafter, embodiments disclosed in the present specification will be described in detail with reference to the accompanying drawings, and the same or similar elements are given the same and similar reference numerals, so duplicate descriptions thereof will be omitted.

The terms “module” and “unit” used for the elements in the following description are given or interchangeably used in consideration of only the ease of writing the specification, and do not have distinct meanings or roles by themselves.

In describing the embodiments disclosed in the present specification, when the detailed description of the relevant known technology is determined to unnecessarily obscure the gist of the present disclosure, the detailed description may be omitted. Further, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in the context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

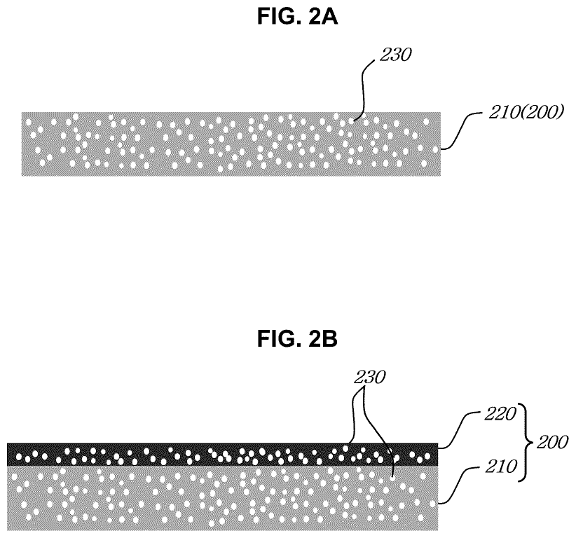

FIG. 2A is a view of a gas diffusion layer for a fuel cell according to an embodiment of the present disclosure.

As shown in the figure, a gas diffusion layer 200 for a fuel cell according to the present disclosure includes a substrate layer 210 inside which a carbon substance 230 is fixedly impregnated inside a support formed of Korean paper.

The substrate layer 210 is formed of Korean paper as a support.

Korean paper is paper formed of at least one selected from the group mulberry fibers, Manila fibers, abaca fibers, natural pulp, and a mixture thereof.

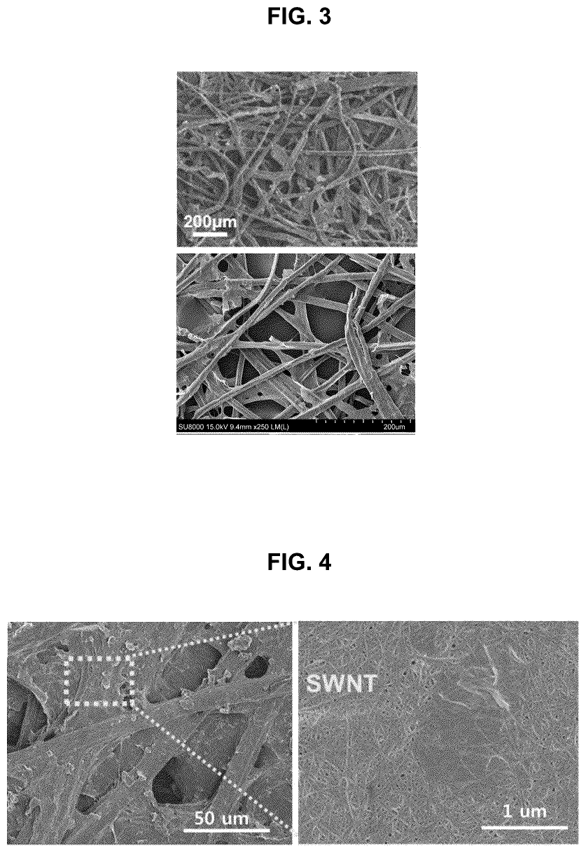

FIG. 3 shows SEM images of Korean paper accounting for the substrate layer in the gas diffusion layer for a fuel cell according to an embodiment of the present disclosure. As can be seen in FIG. 3, Korean paper is paper in which fiber strands are entangled to form an isotropic fibrous structure.

With the isotropic fibrous structure, Korean paper is superb in mechanical strength in all directions, compared to textiles with isotropic fibrous structures, and has an excellent porous structure with a porosity of 50-90%.

In this regard, the Korean paper preferably has a basis weight of 10-200 g/m² and a thickness of 10-200 μm.

When the base weight is lower than 10 g/m², the Korean paper may be torn during the manufacture of the gas diffusion layer due to the low mechanical properties. Particularly, the resulting loose fibrous structure does not allow the carbon substance 230 to be impregnated to a desired level, thus making it difficult to achieve a desired level of electroconductivity.

When the Korean paper has a base weight higher than 200 g/m², the fibrous structure is too dense to impregnate the carbon substance 230 to a desired level, with the consequent attainment of electroconductivity at an undesirable level.

The thickness of Korean paper is determined depending on the base weight. When a base weight of 10-200 g/m² is given under the requirement for a porosity of 50 90%, the Korean paper is manufactured to have a thickness of 10-200 μm.

The carbon material 230, which is impregnated into the support formed of Korean paper, allows the gas diffusion layer to express electroconductivity. In this embodiment, carbon nanotubes (CNT) alone or a mixture of carbon nanotubes (CNT) and a reduced graphene oxide (rGO) is preferably used as the carbon substance 230.

Carbon nanotubes can be fixedly impregnated into Korean paper without a separate binder due to the isotropic fibrous structure of Korean paper (free standing possible).

FIG. 4 shows SEM images of the gas diffusion layer for a fuel cell according to an embodiment of the present disclosure. As can be seen in FIG. 4, carbon nanotubes (CNT) were uniformly dispersed and fixed to the support formed of Korean paper even though a separate binder was not used.

In a typical gas diffusion layer, carbon black is used as the carbon substance 230. The carbon substance 230, such as carbon black, necessarily requires the use of a polymer binder, such as PTFE, for the impregnation or application thereof to the substrate layer 210. However, when used to fix the carbon substance 230 to the substrate layer 210, the polymer binder decreases the electroconductivity. In addition, the polymer binder blocks the pores of the support to decrease the porosity of the support, too.

Hence, carbon black is preferably excluded from candidates for carbon substance 230.

Considering maintenance of excellent electroconductivity, the sole use of carbon nanotubes (CNT) is as the carbon substance 230 is advantageous. For the gas diffusion layer, however, a mixture of carbon nanotubes (CNT) and a reduced graphene oxide (rGO) at a certain ratio may be used as the carbon substance 230 in order to smoothly flow and discharge the water produced because the reduced graphene oxide (rGO) can improve hydrophobicity.

By way of example, when carbon nanotubes (CNT) are used alone as the carbon substance 230 for form a gas diffusion layer, an electroconductivity of 9.00×10¹ S/cm or higher is maintained in the gas diffusion layer.

In contrast, when used as the carbon substance 230, a mixture of carbon nanotubes (CNT) and a reduced graphene oxide (rGO) gives lower electroconductivity to the gas diffusion layer than does the sole carbon nanotubes (CNT), but can improve the hydrophobicity of the gas diffusion layer.

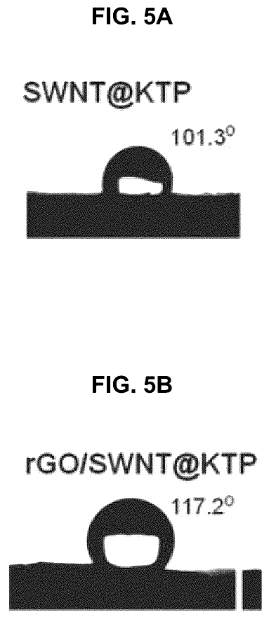

FIG. 5A is a photographic image showing a surface contact angle on a gas diffusion layer for a fuel cell when carbon nanotubes (CNT) are used as the carbon substance 230 according to an embodiment of the present disclosure and FIG. 5B is a photographic image showing a surface contact angle on a gas diffusion layer for a fuel cell when a mixture of carbon nanotubes (CNT) and a reduced graphene oxide (rGO) is used as the carbon substance 230 according to an embodiment of the present disclosure.

As shown in FIG. 5A, the water drop contact angle was 101.3° on the surface of the gas diffusion layer when carbon nanotubes (CNT) were solely used as the carbon substance 230, but the gas diffusion layer in which a mixture of carbon nanotubes (CNT) and a reduced graphene oxide (rGO) was used as the carbon substance 230 exhibited a water drop contact angle of 117.2° on the surface thereof, as shown in FIG. 5B.

Thus, preference is made for using carbon nanotubes (CNT) solely as the carbon substance 230 in terms of electroconductivity of the gas diffusion layer, but for using a combination of carbon nanotubes (CNT) and a reduced graphene oxide (rGO) as the carbon substance 230 in consideration of electroconductivity and surface hydrophobicity of the gas diffusion layer.

When a mixture of carbon nantotubes (CNT) and a reduced graphene oxide (rGO) is used as the carbon substance 230, the mixing ratio therebetween is determined in consideration of electroconductivity and hydrophobicity on the surface.

In this regard, a relatively high portion of the carbon nanotubes (CNT) increases electroconductivity but decreases hydrophobicity whereas a relatively high portion of reduced graphene oxide (rGO) decreases electroconductivity, but increase hydrophobicity.

Therefore, the carbon nanotubes (CNT) and reduced graphene oxide (rGO) are preferably mixed at a weight ratio of 1:1-10:1 to exhibit excellent electroconductivity and high hydrophobicity.

Although the carbon substance 230 was impregnated inside the support formed of Korean paper as described in the foregoing, the impregnation of the carbon substance 230 is not limited to the inside of the support, but may be achieved as the carbon substance 230 be fixed onto the surface by coating.

FIG. 2B is a view of a gas diffusion layer for a fuel cell according to another embodiment of the present disclosure.

As shown in FIG. 2B, the gas diffusion layer for a fuel cell according to another embodiment of the present disclosure includes: a substrate layer 210 in which a carbon substance 230 is impregnated inside a support formed of Korean paper; and a carbon substance layer 220 that is formed as the carbon substance 230 are fixed on the surface of the substrate 210.

In this regard, the carbon substance layer 220, which is formed by fixing the carbon substance 230 onto the surface of the substrate layer 210, is preferably 50 μm or less in thickness in order to maintain a robust fixation state of the carbon substance layer 220 on the substrate layer 210 because no separate binders are employed.

When the thickness of the carbon substance layer 220 exceeds 50 μm, the carbon substance 230 may be not fixed on the surface of the substrate layer 210, but exfoliated.

Below, a description will be given of a method for manufacturing a gas diffusion layer.

A method for manufacturing a gas diffusion layer for a fuel cell according to an embodiment of the present disclosure, which is to manufacture a gas diffusion layer as a constituent member of a unit cell in a fuel cell, includes a support preparation step of preparing a support with Korean paper, a dispersion preparation step of dispersing a carbon substance in a solvent to form a dispersion, a coating step of coating the support with the dispersion, and a thermal treatment step of thermally treating the dispersion-coated support to fix the carbon substance to the support.

The method further includes a drying step of drying the dispersion-coated support before the thermal treatment step.

The support preparation step is to prepare a support with Korean paper.

The Korean paper used herein has a basis weight of 10 to 200 g/m² and a thickness of 10-200 μm to maintain a porosity of 50-90% therein.

The dispersion preparation step is to disperse the carbon substance in a solvent to prepare a dispersion, wherein the carbon substance is a carbon nanotube (CNT) or a mixture of carbon nanotube and reduced graphene oxide (rGO).

Carbon nanotubes (CNT) are dispersed alone or in combination with a reduced graphene oxide (rGO) at a predetermined ratio in the solvent distilled water. In this regard, a surfactant, for example, SDBS may be added to the solvent so as to uniformly disperse the carbon substance.

The coating step is to coat the support with the dispersion. The coating step is carried out so as to sufficiently impregnate the dispersion into the support.

The drying step is to dry the dispersion-coated support. In the drying step, the solvent of the dispersion is evaporated so that only the carbon substance is left as being impregnated into the support.

To this end, the drying step is carried out so that the solvent is allowed to sufficiently vaporize in a natural state without an additional condition. For example, in the drying step, the dispersion-impregnated support is left for 7-9 hours so that the solvent spontaneously evaporates.

The thermal treatment step is to thermally treat the dispersion-impregnated support to fix the carbon substance to the support. In this regard, a proper temperature is maintained to fix the carbon substance to the support.

For example, the thermal treatment is conducted at a temperature 800-900° C. for 1-2 hours.

Under the condition, the carbon substance is robustly fixed while the support Korean paper can be prevented from being damaged.

When the thermal treatment temperature is lower than 800° C., the carbon substance is not robustly fixed to the support, which makes it impossible to attain a desired level of electroconductivity.

At a temperature higher 900° C. for the thermal treatment, the support may be damaged or deformed.

The present disclosure will be further explained with reference to the following Comparative Examples and Examples.

First, electric properties were examined according to temperature in the thermal treatment step.

For this experiment, Korean patent with a basis weight of 17 g/m² was prepared.

To 1 ml of distilled water were added 1 mg of carbon nanotubes (CNT) as a carbon substance and 1 mg of SDBD as a surfactant, followed by stirring at a speed of 50 to 1000 rpm for 30 to 180 minutes with a stirrer. Sonication for 30 minutes in an ultrasonic processor gave a dispersion.

Subsequently, the dispersion was applied for 15 rounds in an amount of 2 ml per round to the prepared support, using a doctor blade at a speed of 10 mm/s. The support was then washed and dried.

Afterward, thermal treatment was performed under a mixed reducing atmosphere including hydrogen and argon in a furnace.

The conditions for the thermal treatment step were set forth for the Examples and Comparative Examples as shown in Table 1, below. The gas diffusion layers thus obtained were measured for resistance, sheet resistance, specific resistance, and electroconductivity, and the measurements are summarized in Table 2, below.

TABLE 1

| | Basis | | | | | |
|---|---|---|---|---|---|---|
| | Weight of | Dis- | | | Thermal | Thermal |
| | Korean | persion | Coating | Drying | treatment | treatment |
| | paper | Conc. | speed | time | Temp. | time |
| Sample | (g/m²) | (mg/ml) | (mm/s) | (hour) | (° C.) | (hour) |
| C. Ex. 1 | 17 | 1 | 10 | 8 | 300 | 2 |
| C. Ex. 2 | 17 | 1 | 10 | 8 | 400 | 2 |
| C. Ex. 3 | 17 | 1 | 10 | 8 | 500 | 2 |
| C. Ex. 4 | 17 | 1 | 10 | 8 | 600 | 2 |
| C. Ex. 5 | 17 | 1 | 10 | 8 | 700 | 2 |
| Ex. 1 | 17 | 1 | 10 | 8 | 800 | 2 |
| Ex. 2 | 17 | 1 | 10 | 8 | 900 | 2 |
| C. Ex. 6 | 17 | 1 | 10 | 8 | 0 | 2 |

TABLE 2

| | | | | Electro- |
|---|---|---|---|---|
| | Resistance | Sheet resist. | Specific resist. | conductivity |
| Sample | (Ω) | (Ω/□) | (Ω · cm) | S/cm |
| C. Ex. 1 | 0.83*10⁰ | 3.80*10⁰ | 3.29*10⁻² | 3.31*10¹ |
| C. Ex. 2 | 0.91*10⁰ | 4.09*10⁰ | 3.02*10⁻² | 3.72*10¹ |
| C. Ex. 3 | 0.84*10⁰ | 3.94*10⁰ | 2.73*10⁻² | 3.94*10¹ |
| C. Ex. 4 | 6.15*10⁻¹ | 2.94*10⁰ | 2.25*10⁻² | 4.45*10¹ |
| C. Ex. 5 | 6.03*10⁻¹ | 2.79*10⁰ | 2.32*10⁻² | 4.58*10¹ |
| Ex. 1 | 1.97*10⁻¹ | 7.88*10⁻¹ | 1.03*10⁻² | 9.25*10¹ |
| Ex. 2 | 2.02*10⁻¹ | 7.65*10⁻¹ | 1.0*10⁻² | 9.96*10¹ |
| C. Ex. 6 | 2.94*10⁻¹ | 1.32*10⁰ | 2.21*10⁻² | 5.03*10¹ |

As is understood from data of Tables 1 and 2, Comparative Example 6 with no thermal treatments were relatively very poor in sheet resistance. Comparative Examples 1 to 5 with thermal treatment temperatures lower than the lower limit of the suggested range were observed to be high in specific resistance and low in electroconductivity, compared to Examples 1 and 2.

Particularly, Comparative Examples 1 to 3 were very lower in resistance than Examples 1 and 2.

Comparison was made between a conventional gas diffusion layer and Examples 1 and 2. To this end, a gas diffusion layer manufactured using carbon paper as a substrate layer and carbon black as a carbon substance, with a binder applied thereto, was measured for resistance, sheet resistance, specific resistance, and electroconductivity, and the measurements are summarized in Table 3, below.

TABLE 3

| | | | | Electro- |
|---|---|---|---|---|
| | Resistance | Sheet resist. | Specific resist. | conductivity |
| Sample | (Ω) | (Ω/□) | (Ω · cm) | S/cm |
| Conventional | 2.93*10⁰ | 1.27*10⁰ | 2.01*10⁻² | 5.05*10¹ |
| Ex. 1 | 1.97*10⁻¹ | 7.88*10⁻¹ | 1.03*10⁻² | 9.25*10¹ |
| Ex. 2 | 2.02*10⁻¹ | 7.65*10⁻¹ | 1.0*10⁻² | 9.96*10¹ |

As shown in Table 3, Examples 1 and 2 were lower in resistance and specific resistance and higher in sheet resistance and electroconductivity, compared to the conventional gas diffusion layer.

Although the present disclosure has been described with reference to the accompanying drawings and the above exemplary embodiments thereof, the present disclosure is not limited thereto but defined by the appended claims. Therefore, those skilled in the art may make various modifications and changes to the present disclosure without departing from the technical idea of the present disclosure defined by the appended claims.

1. A method for manufacturing a gas diffusion layer as a constituent of a unit cell in a fuel cell, the method comprising:
preparing a support with Korean paper;
dispersing a carbon substance in a solvent to form a dispersion;
coating the support with the dispersion; and
thermally treating the dispersion-coated support to fix the carbon substance to the support.

2. The method of claim 1, wherein the Korean paper has a base weight of 10 to 200 g/m² and a thickness of 10-200 μm.

3. The method of claim 1, wherein the Korean paper has a porosity of 50-90%.

4. The method of claim 1, wherein the carbon substance is a carbon nanotube (CNT) or a mixture of carbon nanotube and reduced graphene oxide (rGO).

5. The method of claim 4, wherein the mixture comprises carbon nanotube (CNT) and reduced graphene oxide (rGO) at a weight ratio of 1:1-10:1.

6. The method of claim 1, wherein the dispersion is free of a binder.

7. The method of claim 1, wherein the thermal treatment is carried out at a temperature of 800-900° C.

8. The method of claim 1, wherein the method further comprises drying the dispersion-coated support before thermally treating the dispersion-coated support.

9. The method of claim 8, wherein the drying is carried out by maintaining the dispersion-coated support for 7-9 hours in a natural state to spontaneously dry the support.

10. A gas diffusion layer for a fuel cell, being used as a constituent of a unit cell in the fuel cell and comprising a substrate layer in which a carbon substance is fixedly impregnated inside a support formed of Korean paper.

11. The gas diffusion layer of claim 10, wherein the Korean paper forming the substrate layer has a base weight of 10 to 200 g/m² and the substrate layer has a thickness of 10-200 μm.

12. The gas diffusion layer of claim 10, wherein the substrate layer has a porosity of 50-90%.

13. The gas diffusion layer of claim 10, wherein the carbon substance comprises carbon nanotubes or a mixture of carbon nanotubes (CNT) and reduced graphene oxide (rGO).

14. The gas diffusion layer of claim 13, wherein when the carbon substance comprises carbon nanotubes alone, the gas diffusion layer has an electroconductivity of 9.00×10¹ S/cm or higher.

15. The gas diffusion layer of claim 13, wherein when the carbon substance comprises a mixture of carbon nanotubes (CNT) and a reduced graphene oxide (rGO), the gas diffusion layer surface has a water drop contact angle of 117° or greater.

16. The gas diffusion layer of claim 10, further comprising a carbon substance layer formed by fixing a carbon substance onto the surface of the substrate layer.

17. The gas diffusion layer of claim 10, wherein the carbon material layer has a thickness of 50 μm or less.
